(19) United States
(12) Patent Application Publication
(10) Pub. No.: US 2026/0059187 A1
(43) Pub. Date: Feb. 26, 2026

(54) IMAGING CONTROL DEVICE AND IMAGING APPARATUS

(71) Applicant: SONY GROUP CORPORATION, Tokyo (JP)

(72) Inventors: Yusuke MIMURA, Tokyo (JP); Shohei SAKAGUCHI, Tokyo (JP)

(21) Appl. No.: 19/105,357

(22) PCT Filed: Jul. 10, 2023
(86) PCT No.: PCT/JP2023/025484

§ 371 Date: Feb. 21, 2025

(30) Foreign Application Priority Data
Sep. 2, 2022 (JP) 2022-140338

(51) Int. Cl. H04N 23/611; H04N 23/71; H04N 23/73; H04N 23/74; H04N 23/76; H04N 23/81; H04N 23/88

(52) U.S. Cl. CPC H04N 23/611; H04N 23/71; H04N 23/73; H04N 23/74; H04N 23/76; H04N 23/81; H04N 23/88

(57) ABSTRACT

An imaging control device of the present disclosure includes a detector, an extractor, and a controller. The detector detects, as a region of interest, a face region of a person in a captured image obtained by an imaging apparatus. The extractor extracts a skin region in the region of interest detected by the detector. The controller performs an imaging control on the imaging apparatus on the basis of information obtained from the skin region extracted by the extractor.

### TECHNICAL FIELD

The present disclosure relates to an imaging control device and an imaging apparatus.

### BACKGROUND ART

There is a technique of face-priority AE (Auto Exposure) in which a face region of a person in a captured image is detected by a rectangular detection frame and an exposure control is performed on the basis of a detection result of the face region (see PTL 1).

### CITATION LIST

### Patent Literature

PTL 1: Japanese Unexamined Patent Application Publication No. 2017-169240

### SUMMARY OF THE INVENTION

In the technique described above, for example, when there is a dark blocking object such as hair or sunglasses inside a detection frame, a detection value is greatly deviated from that of a skin region. This can make brightness higher than it actually is, and can lead to a degradation of image quality of a skin part. For such a reason, in the technique described above, even if a side of a face is detected, the detection value is not used for face-priority AE, which makes it difficult to make brightness of a skin of the side of the face appropriate.

It is desirable to provide an imaging control device and an imaging apparatus that each make it possible to increase detection accuracy of a face region and to perform an appropriate imaging control.

An imaging control device according to an embodiment of the present disclosure includes a detector, an extractor, and a controller. The detector detects, as a region of interest, a face region of a person in a captured image obtained by an imaging apparatus. The extractor extracts a skin region in the region of interest detected by the detector. The controller performs an imaging control on the imaging apparatus on the basis of information obtained from the skin region extracted by the extractor.

An imaging apparatus according to an embodiment of the present disclosure includes an imager, a detector, an extractor, and a controller. The detector detects, as a region of interest, a face region of a person in a captured image obtained by the imager. The extractor extracts a skin region in the region of interest detected by the detector. The controller performs an imaging control on the basis of information obtained from the skin region extracted by the extractor.

In the imaging control device or the imaging apparatus according to the embodiment of the present disclosure, the face region of the person in the captured image is detected as the region of interest, and the skin region in the detected region of interest is extracted. The imaging control is performed on the basis of the information obtained from the extracted skin region.

### BRIEF DESCRIPTION OF DRAWINGS

FIG. 1 is a block diagram schematically illustrating a configuration example of an imaging apparatus according to an embodiment of the present disclosure.

FIG. 2 is a block diagram schematically illustrating a configuration example of a camera controller as an imaging control device according to the embodiment.

FIG. 3 is an explanatory diagram schematically illustrating an example of setting a region of interest by a region-of-interest detector.

FIG. 4 is an explanatory diagram schematically illustrating an example of a processing operation to be performed by a skin region extractor.

FIG. 5 is an explanatory diagram schematically illustrating an example of a processing operation to be performed by a region-of-interest brightness calculator.

FIG. 6 is an explanatory diagram schematically illustrating an example of transition of a mixture ratio of a skin region detection value.

FIG. 7 is an explanatory diagram schematically illustrating an example of a method of calculating reliability.

FIG. 8 is an explanatory diagram schematically illustrating an example of application to auto white balance by the imaging control device according to the embodiment.

FIG. 9 is an explanatory diagram schematically illustrating an example of application to noise reduction by the imaging control device according to the embodiment.

### MODES FOR CARRYING OUT THE INVENTION

Some embodiments of the present disclosure will be described below in detail with reference to the drawings. Note that the description will be given in the following order.

### 1. Embodiment

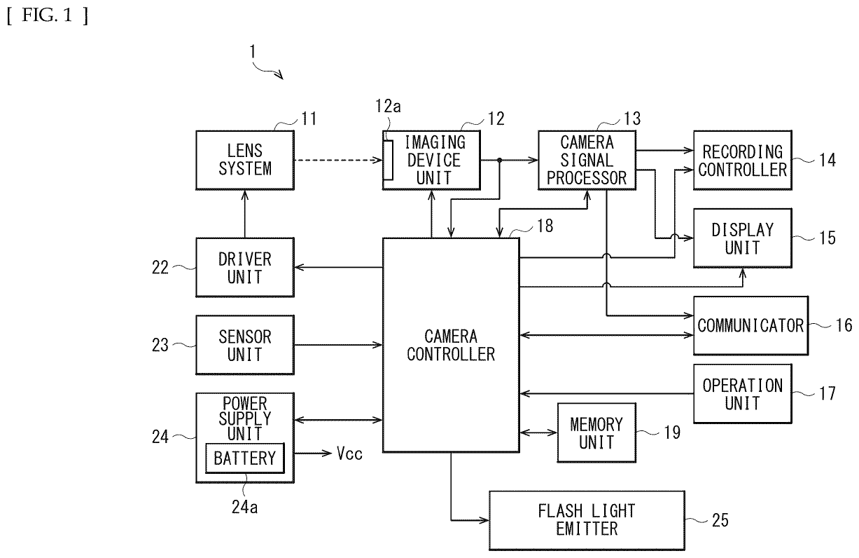

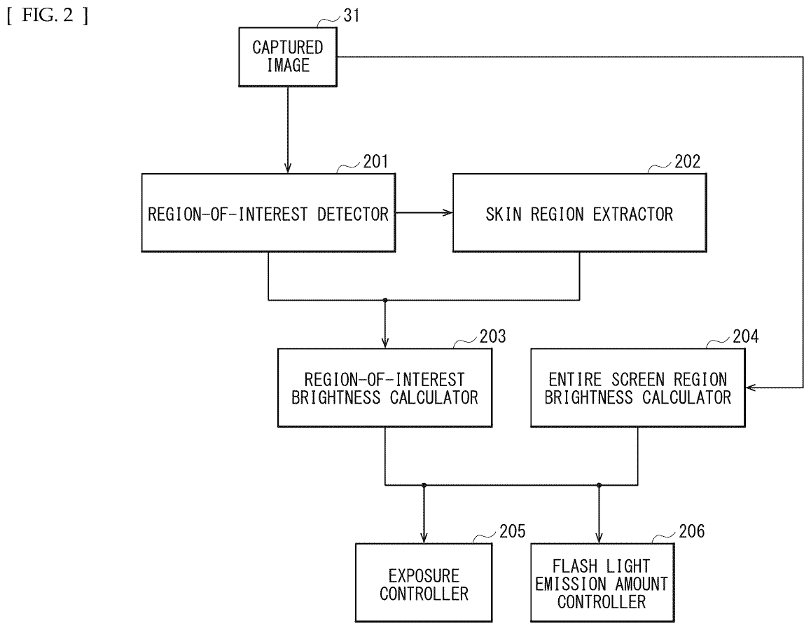

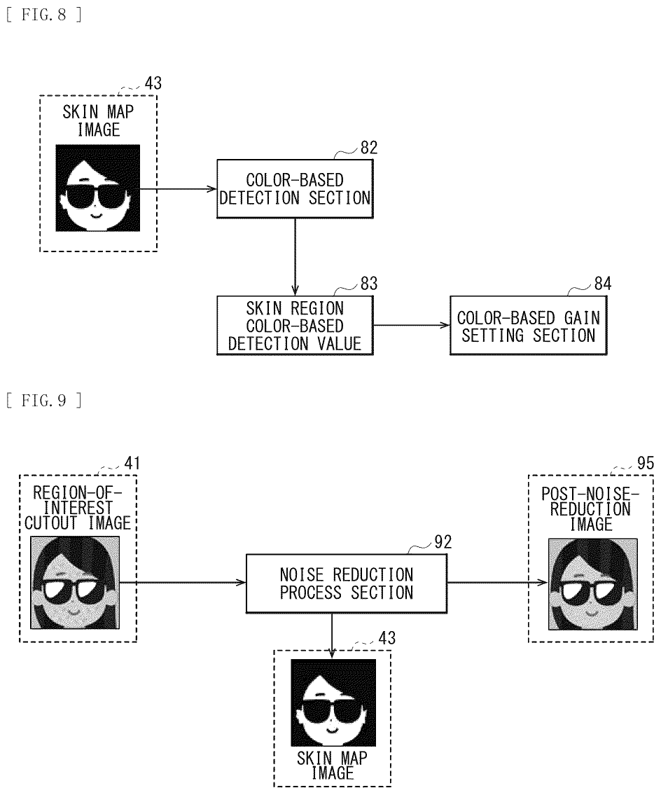

1.1 Overall Configuration Example and Operation of Imaging Apparatus (FIG. 1)
1.2 Configuration Example and Operation of Imaging Control Device (FIGS. 2 to 7)
1.3 Application Examples (FIGS. 8 and 9)
1.4 Effects

2. Other Embodiments

### 1. Embodiment

### 1.1 Overall Configuration Example and Operation of Imaging Apparatus

FIG. 1 schematically illustrates a configuration example of an imaging apparatus 1 according to an embodiment of the present disclosure.

The imaging apparatus 1 includes, for example, a lens system 11, an imaging device unit 12, a camera signal processor 13, a recording controller 14, a display unit 15, a communicator 16, an operation unit 17, a camera controller 18, a memory unit 19, a driver unit 22, a sensor unit 23, a power supply unit 24, and a flash light emitter 25.

The lens system 11 and the imaging device unit 12 correspond to one specific example of an “imager” in the technique of the present disclosure.

The lens system 11 includes, for example, a lens such as a zoom lens or a focus lens, and a diaphragm mechanism. The lens system 11 guides light (incident light) from a subject and collects the light to the imaging device unit 12.

The imaging device unit 12 includes, for example, an image sensor 12a (an imaging device) of, for example, a CMOS (Complementary Metal Oxide Semiconductor) type or a CCD (Charge Coupled Device) type.

The imaging device unit 12 performs, for example, a CDS (Correlated Double Sampling) process, an AGC (Automatic Gain Control) process, and the like on an electric signal obtained by photoelectrically converting light received by the image sensor 12a, and further performs an A/D (Analog/Digital) conversion process thereon. Further, the imaging device unit 12 outputs an imaging signal as digital data to a unit such as the camera signal processor 13 or the camera controller 18 in a later stage. The imaging signal may include signals of a plurality of color components. For example, the imaging signal may include R (red), G (green), and B (blue) as the plurality of color components.

The camera signal processor 13 is configured as, for example, an image processing processor, and includes, for example, a DSP (Digital Signal Processor) or the like. The camera signal processor 13 performs various kinds of signal processing on a digital signal (the imaging signal) from the imaging device unit 12. For example, the camera signal processor 13 performs preprocessing, a synchronization process, a YC generation process, a resolution conversion process, a file formation process, and the like, as camera processes. In addition, the camera signal processor 13 performs a noise reduction process in accordance with a control from the camera controller 18.

In the preprocessing, a process such as a clamping process or a correction process is performed on the imaging signal from the imaging device unit 12. In the clamping process, a black level of each of R, G, and B is clamped to a predetermined level. The correction process is performed between color channels of R, G, and B. In addition, in the preprocessing, white balance is adjusted in accordance with a control from the camera controller 18.

In the synchronization process, a color separation process is so performed that image data related to each pixel has all of the color components of R, G, and B. For example, in a case of an imaging device in which a Bayer color filter is used, a demosaicing process is performed as the color separation process.

In the YC generation process, a luminance (Y) signal and a color (C) signal are generated (separated) from the image data of R, the image data of G, and the image data of B.

In the resolution conversion process, the resolution conversion process is performed on the image data that has been subjected to various kinds of signal processing.

In the file formation process, file formation for recording, communication, or the like is performed for, for example, the image data that has been subjected to the various kinds of processing described above. The file formation for recording, communication, or the like is performed by, for example: compression encoding for recording, communication, or the like; formatting; and generation, addition, or the like of metadata.

For example, an image file in a format such as JPEG, TIFF (Tagged Image File Format), or GIF (Graphics Interchange Format) is generated as a still image file. Further, an image file may be generated in an MP4 format used in recording of MPEG-4 moving images and sounds. Note that the image file may be generated as raw (RAW) image data.

The camera signal processor 13 generates the metadata as metadata including, for example: information regarding processing parameters in the camera signal processor 13; various control parameters acquired from the camera controller 18; information indicating an operation state of a unit such as the lens system 11 or the imaging device unit 12; mode setting information; imaging environment information (such as date and time, or location); identification information regarding the imaging apparatus 1 itself; information regarding a mounted lens; information (name and identification information) regarding a photographer registered in advance; and IPTC (International Press Telecommunications Council) metadata.

Note that the IPTC metadata is metadata in a format established by a media company organization, and is data in which various kinds of information including, for example, “description/caption”, “description writer”, “headline”, “keyword”, and the like are describable.

The recording controller 14 performs recording and reproduction on, for example, a recording medium including a nonvolatile memory. The recording controller 14 performs a process of recording, for example, an image such as moving image data or still image data, or metadata on, for example, the recording medium.

The recording controller 14 may be in any of various actual forms. For example, the recording controller 14 may be configured as a flash memory and a write/read circuit thereof that are built in the imaging apparatus 1. Alternatively, the recording controller 14 may be in a form including a card recording and reproducing unit that performs recording and reproducing access to a recording medium attachable to and detachable from the imaging apparatus 1. The recording medium attachable to and detachable from the imaging apparatus 1 is, for example, a memory card (such as a portable flash memory). Alternatively, the recording controller 14 may be implemented as, for example, an HDD (Hard Disk Drive) as a form built in the imaging apparatus 1.

The display unit 15 is a display unit that performs various kinds of display for a person who performs imaging. The display unit 15 may be, for example, a display panel, a viewfinder, or the like including a display device to be disposed in a housing of the imaging apparatus 1. The display device may be, for example, a liquid crystal panel (LCD: Liquid Crystal Display) or an organic EL (Electro-Luminescence) display.

The display unit 15 performs various kinds of display on a display screen on the basis of an instruction from the camera controller 18. For example, the display unit 15 displays a reproduced image of the image data read by the recording controller 14 from the recording medium. Further, in some cases, the display unit 15 receives image data of a captured image that has been subjected to resolution conversion for display by the camera signal processor 13, and performs display on the basis of the image data of the captured image on the basis of an instruction from the camera controller 18. This allows for display of the captured image captured during composition checking or moving image recording, i.e., what is called a through image (a monitoring image of the subject). In addition, the display unit 15 performs, on the basis of an instruction from the camera controller 18, display, on the screen, that serves as, for example, various operation menus, icons, or messages, i.e., a GUI (Graphical User Interface).

The communicator 16 collectively represents, for example, various communication devices and communication process circuits to be mounted on the imaging apparatus 1. Various communication circuits and various communication devices are provided that are able to perform, as the communication by the communicator 16, communication via an external communication network (external network communication), local communication with a portable terminal, and in addition, master/slave communication with corresponding device in another imaging apparatus as one example of the local communication.

The imaging apparatus 1 thus performs transmission and reception of the captured image data (such as the still image file or a moving image file), the metadata, the various parameters, etc. with, for example, an external information processor, an external imaging apparatus, an external display apparatus, an external recording apparatus, an external reproducing apparatus, and the like. More specifically, the communicator 16 includes, as a network communication unit, for example, a part or all of: a function of performing communication by a mobile body communication network such as 4G or 5G, an Internet line, a home network, a LAN (Local Area Network), or the like; a function of performing short-range wireless communication such as Bluetooth (Bluetooth: registered trade mark), Wi-Fi (registered trademark) communication, or NFC (Near Field Communication); a function of performing communication such as infrared communication; and a function of performing wired communication with another device.

The operation unit 17 collectively represents an input device that allows a user to perform various operation inputs. Specifically, the operation unit 17 represents various operation members (including, for example, a key, a dial, a touch panel, and a touch pad) provided in the housing of the imaging apparatus 1. An operation by the user is detected by the operation unit 17, and a signal based on the inputted operation is transmitted to the camera controller 18.

The camera controller 18 includes a microcomputer (a calculation processor) including a CPU (Central Processing Unit).

The memory unit 19 holds, for example, information that the camera controller 18 uses for processing. The illustrated memory unit 19 collectively represents, for example, a ROM (Read Only Memory), a RAM (Random Access Memory), a flash memory, and the like.

The memory unit 19 may be a memory region built in a microcomputer chip as the camera controller 18, or may include a separate memory chip.

The camera controller 18 controls the imaging apparatus 1 as a whole by executing a program stored in, for example, the ROM or the flash memory of the memory unit 19. For example, the camera controller 18 controls a shutter speed of the imaging device unit 12, gives instructions regarding various kinds of signal processing in the camera signal processor 13, and controls an operation such as an imaging operation or a recording operation based on an operation by the user and a reproduction operation of the recorded image file. In addition, the camera controller 18 controls an operation of each necessary unit. For example, the camera controller 18 controls: an operation of the lens system 11 such as zooming, focusing, or aperture adjustment in a lens barrel; a user interface operation; and setting of, for example, a communication method or a transmission destination of the communicator 16.

Further, in one embodiment, in particular, the camera controller 18 performs an exposure control, regarding the captured image, based on a photometric value. Note that details of the exposure control according to the embodiment will be described later. Further, the camera controller 18 in the present example performs a process of detecting the region of interest from the captured image. The region of interest and the detection process thereof will also be described later.

The RAM in the memory unit 19 is used as a working area at a time when the CPU of the camera controller 18 performs various kinds of data processing, and is used to temporarily store, for example, data and programs. For example, the ROM or the flash memory (a nonvolatile memory) in the memory unit 19 is used to store, for example, an OS (Operating System) for the CPU to control each unit, a content file such as an image file, an application program for various operations, firmware, and various kinds of setting information. Examples of the various kinds of setting information include communication setting information and exposure setting (such as a shutter speed or an F value) as setting information regarding an imaging operation. The examples of the various kinds of setting information further include mode setting, white balance setting as setting information regarding image processing, color setting, setting regarding an image effect, custom key setting as setting information regarding operability, and display setting.

The driver unit 22 is provided with motor drivers including, for example, a motor driver for a zoom lens drive motor, a motor driver for a focus lens drive motor, and a motor driver for a motor of the diaphragm mechanism. These motor drivers each apply a drive current to the corresponding driver in accordance with an instruction from the camera controller 18. These motor drivers thus allow for, for example, movement of a lens such as the focus lens or the zoom lens, and opening and closing of diaphragm blades of the diaphragm mechanism.

The sensor unit 23 collectively represents various sensors to be mounted on the imaging apparatus 1. For example, an IMU (inertial measurement unit: inertial measurement unit) is mounted as the sensor unit 23. For example, an angular velocity is detectable by an angular velocity (gyro) sensor of three axes of pitch, yaw, and roll, and an acceleration is detectable by an acceleration sensor. In addition, for example, a sensor such as a position information sensor or an illuminance sensor is mounted as the sensor unit 23 in some cases. In addition, it is assumed that a ranging sensor is provided as the sensor unit 23. A distance from the imaging apparatus 1 to the subject is measurable by the ranging sensor at the time of the imaging. It is possible to add the distance information as the metadata for the captured image. Various kinds of information detected by the sensor unit 23 including, for example, position information, distance information, illuminance information, and IMU data are added, as metadata, to the captured image, together with date and time information managed by the camera controller 18.

The power supply unit 24 uses a battery 24a as a power supply, and outputs a power supply voltage Vcc required for each unit. On and off of supplying the power supply voltage Vcc by the power supply unit 24, that is, on and off of the power supply of the imaging apparatus 1 is controlled by the camera controller 18. In addition, a capacity of the battery 24a, that is, a remaining battery capacity, is detectable by the camera controller 18. Note that the power supply unit 24 may be configured to output the power supply voltage Vcc on the basis of an external power supply, for example, by allowing an AC adapter to be coupled thereto or by receiving a direct-current power supply voltage.

The flash light emitter 25 causes, for example, a xenon tube or an LED (Light Emitting Diode) light source to emit light so that a light emission amount determined by a light emission amount calculation by the camera controller 18 is achieved. This makes it possible to shoot a bright image even if the subject is dark.

### 1.2 Configuration Example and Operation of Imaging Control Device

### [Configuration Example and Operation of Camera Controller 18]

FIG. 2 schematically illustrates a configuration example of the camera controller 18 as an imaging control device according to the embodiment.

The camera controller 18 includes a region-of-interest detector 201, a skin region extractor 202, a region-of-interest brightness calculator 203, an entire screen region brightness calculator 204, an exposure controller 205, and a flash light emission amount controller 206.

The region-of-interest detector 201 is a detector that detects, as the region of interest, a face region of a person in a captured image 31 obtained by the imager of the imaging apparatus 1.

The skin region extractor 202 is an extractor that extracts a skin region in the region of interest detected by the region-of-interest detector 201.

The region-of-interest brightness calculator 203 is a brightness calculator that calculates, as information obtained from the skin region, a brightness of the region of interest on the basis of a detection value of a brightness of the skin region extracted by the skin region extractor 202.

The entire screen region brightness calculator 204 calculates a brightness of an entire region of the captured image 31 while the region-of-interest brightness calculator 203 performs the calculation process of the brightness of the region of interest.

The camera controller 18 is a controller that performs an imaging control on the imaging apparatus 1 on the basis of the information obtained from the skin region extracted by the skin region extractor 202. In particular, the exposure controller 205 is a controller that performs, as the imaging control, the exposure control on the imager of the imaging apparatus 1, on the basis of information regarding the brightness of the region of interest calculated by the region-of-interest brightness calculator 203. In the exposure control, a final exposure may be determined taking into account the brightness of the entire region of the captured image 31.

In addition, the flash light emission amount controller 206 is a controller that performs, as the imaging control, a flash light emission amount control on the flash light emitter 25 of the imaging apparatus 1, on the basis of the information regarding the brightness of the region of interest calculated by the region-of-interest brightness calculator 203.

### [Region-of-Interest Detector 201]

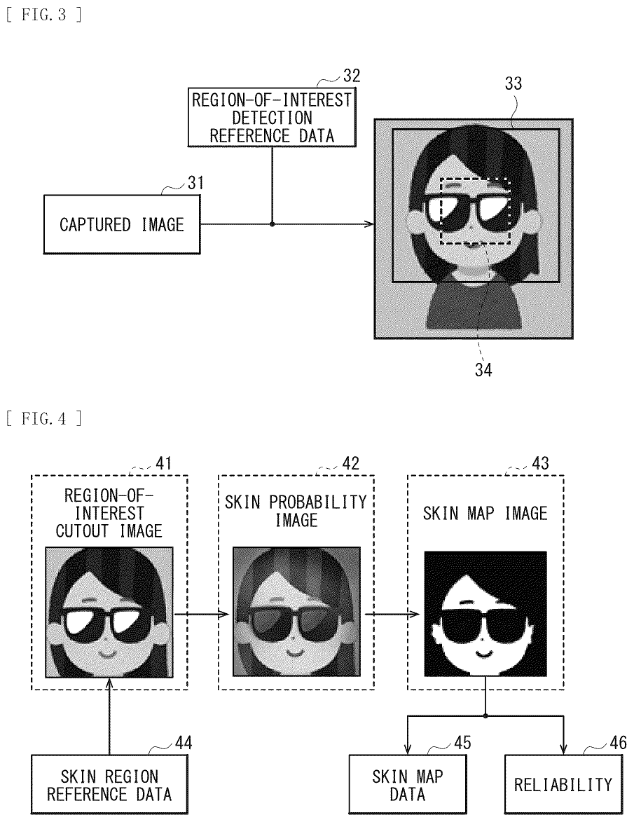

FIG. 3 schematically illustrates an example of setting the region of interest by the region-of-interest detector 201.

The region-of-interest detector 201 set a region-of-interest detection frame 33 in the captured image 31 on the basis of region-of-interest detection reference data 32. The region-of-interest detection frame 33 is a frame for detecting the region of interest. In addition, the region-of-interest detector 201 sets a rectangular detection frame 34 inside the region-of-interest detection frame 33. The rectangular detection frame 34 is set at a middle portion of the region-of-interest detection frame 33, for example.

### [Skin Region Extraction Unit 202]

FIG. 4 schematically illustrates an example of a processing operation to be performed by the skin region extractor 202.

The skin region extractor 202 generates a skin probability image 42 from a region-of-interest cutout image 41 on the basis of skin region reference data 44. Learning data that has been learned in advance is used as the skin region reference data 44. The skin region reference data 44 includes, for example, skin color learning data and skin position learning data. The skin color learning data includes information regarding closeness to a skin color space. The skin position learning data includes probability information regarding a position at which a skin is likely to be present. In addition, the skin position learning data may also include learning data regarding a face direction. This makes it easier to extract the skin region, for example, even with a side of the face. The skin probability image 42 is, for example, an image in which a luminance value is high in a pixel having a color closer to the skin color space or at a position at which the skin is likely to be present, and the luminance value is low in other regions.

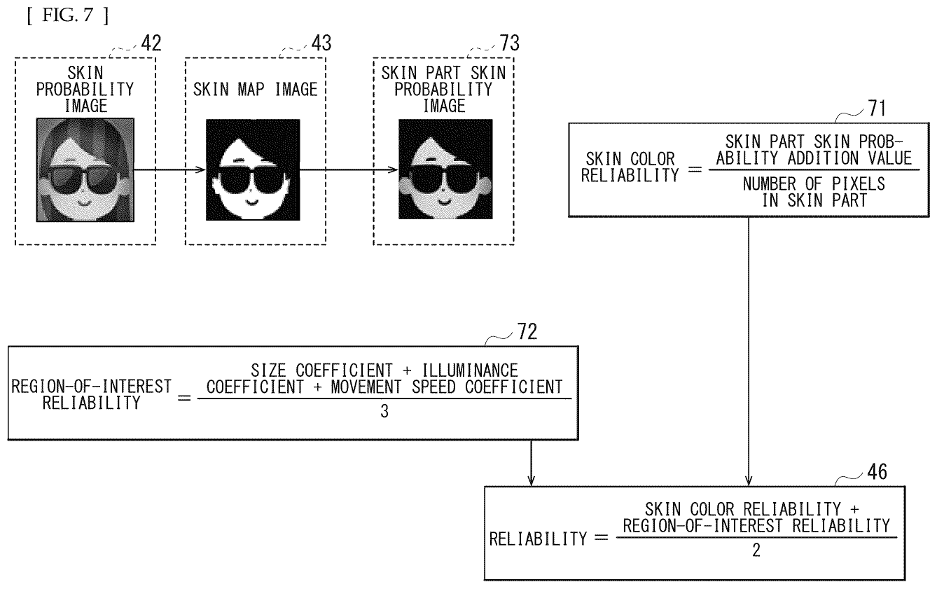

The skin region extractor 202 generates a skin map image 43 by binarizing the skin probability image 42 on the basis of a threshold having a value set as desired. In the skin map image 43, for example, a pixel having a high luminance is regarded as the skin, and a pixel having a low luminance is regarded as something other than the skin. The skin region extractor 202 outputs skin map data 45 and reliability (reliability of the skin region) 46 on the basis of the skin map image 43. The skin map data 45 may be data compressed in accordance with the same rule as the skin map image 43 or in accordance with a certain rule. A calculation example of the reliability 46 will be described later with reference to FIG. 7.

### [Region-of-Interest Brightness Calculator 203]

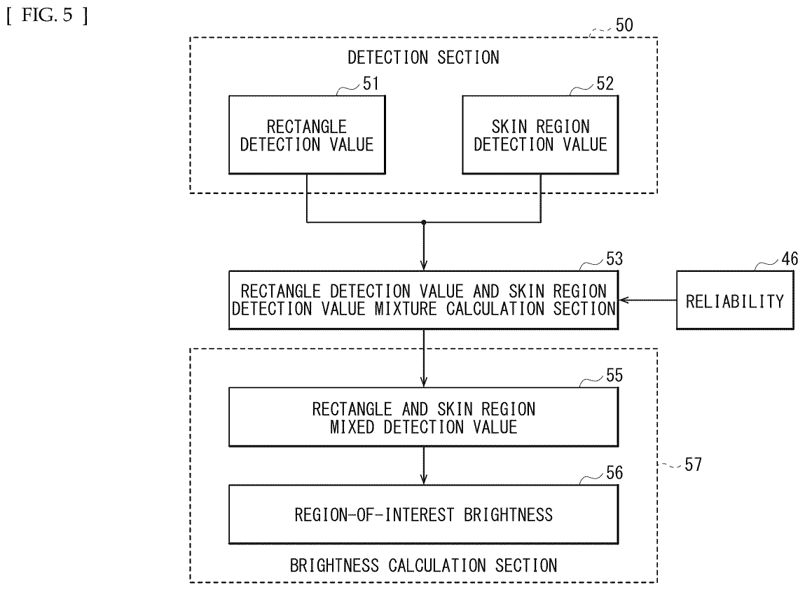

FIG. 5 schematically illustrates an example of a processing operation to be performed by the region-of-interest brightness calculator 203.

The region-of-interest brightness calculator 203 includes a detection section 50, a rectangle detection value and skin region detection value mixture calculation section 53, and a brightness calculation section 57.

The region-of-interest brightness calculator 203 calculates, as the information obtained from the skin region, a region-of-interest brightness 56 on the basis of a detection value of the brightness of the skin region (a skin region detection value 52) and a detection value of a brightness inside the rectangular detection frame 34 (a rectangle detection value 51).

The detection section 50 sets, to the rectangle detection value 51, a value based on detection inside the rectangular detection frame 34 set inside the region-of-interest detection frame 33. In addition, the detection section 50 sets, to the skin region detection value 52, a value based on detection of the skin region extracted by the skin region extractor 202.

The rectangle detection value and skin region detection value mixture calculation section 53 mixes the rectangle detection value 51 and the skin region detection value 52 on the basis of the reliability 46. The brightness calculation section 57 sets the mixed detection value to a rectangle and skin region mixed detection value 55, and calculates the region-of-interest brightness 56 on the basis of the rectangle and skin region mixed detection value 55.

### [Transition of Mixture Ratio of Skin Region Detection Value 52]

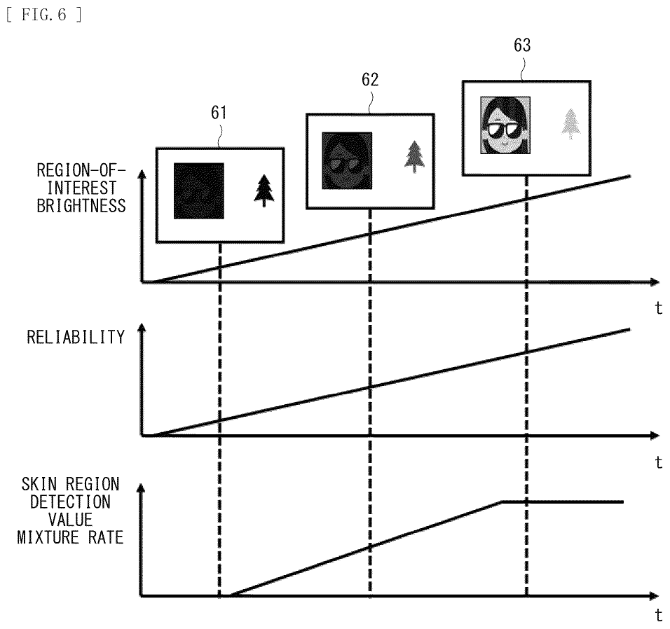

FIG. 6 schematically illustrates an example of transition of a mixture ratio of the skin region detection value 52. An upper part of FIG. 6 illustrates an example of temporal transition of the region-of-interest brightness 56. A middle part of FIG. 6 illustrates an example of temporal transition of the reliability 46. A lower part of FIG. 6 illustrates an example of temporal transition of a mixture rate of the skin region detection value 52.

In a case where the region-of-interest brightness 56 is dark as in an image 61, the reliability 46 is low, the mixture rate of the skin region detection value 52 is also low, and a mixture rate of the rectangle detection value 51 is high. In this case, the rectangle detection value 51 is in a low state, and in order to make the region of interest brighter, the exposure controller 205 performs the exposure control to gradually control the exposure to allow the entire image to be gradually brighter.

This allows the region of interest to be gradually brighter as in an image 62. At this time, the reliability 46 increases, which allows the mixture rate of the rectangle detection value 51 and the mixture rate of the skin region detection value 52 to be about the same. An increase in the region-of-interest brightness 56 further increases the reliability 46. When the reliability 46 exceeds a certain threshold, the mixture rate of the skin region detection value 52 becomes 100% (an image 63).

As described above, in a situation where the region of interest is dark and it is difficult to extract the skin region, the camera controller 18 increases the mixture rate of the rectangle detection value 51. In a situation where the region-of-interest brightness 56 is sufficiently bright, the camera controller 18 increases the mixture rate of the skin region detection value 52. This allows for the exposure control optimum for the skin region while compensating for a shortcoming of skin region extraction, i.e., that it is difficult to extract the skin region when the skin is in a dark state. Similarly, this allows for the flash light emission amount control optimum for the skin region.

### [Method of Calculating Reliability 46]

FIG. 7 schematically illustrates an example of a method of calculating the reliability 46.

The skin region extractor 202 calculates the reliability 46 on the basis of, for example, the information regarding the closeness to the skin color space, the probability information regarding the position at which the skin is likely to be present, and information regarding a state of the region of interest at a time of being detected by the region-of-interest detector 201. The information regarding the state of the region of interest at the time of being detected includes, for example, information regarding a size of the region of interest, information regarding a movement speed of the region of interest, and information regarding the region-of-interest brightness 56.

The skin region extractor 202 generates the skin probability image 42 and the skin map image 43 (FIG. 4). The skin region extractor 202 generates a skin part skin probability image 73 on the basis of the skin probability image 42 and the skin map image 43.

The skin region extractor 202 sets, to a skin part skin probability addition value, a value in which skin probabilities, based on a pixel unit, of the skin part indicated in the skin part skin probability image 73 are added up. The skin region extractor 202 sets, to skin color reliability 71, a value in which the skin part skin probability addition value is divided by the number of pixels in the skin part.

$$Skin color reliability = ( skin part skin probability addition value ) / ( number of pixels in skin part ) .$$

Further, the skin region extractor 202 calculates region-of-interest reliability 72 on the basis of the following calculation expression, in addition to the skin color reliability 71.

$$Region - of - interest reliability = ( size coefficient + illuminance coefficient + movement speed coefficient ) / 3 .$$

Here, each of the coefficients means as follows.

Size coefficient: 0.0 (the region of interest is small) to 1.0 (the region of interest is large)
Illuminance coefficient: 0.0 (the region of interest is dark) to 1.0 (the region of interest is bright)
Movement speed coefficient: 0.0 (the region of interest moves fast) to 1.0 (the region of interest moves slowly)

The skin region extractor 202 calculates the reliability 46 on the basis of the following calculation expression on the basis of the skin color reliability 71 and the region-of-interest reliability 72.

$$Reliability = ( skin color reliability + region of interest reliability ) / 2.$$

### 1.3 Application Examples

### [Example of Application to Auto White Balance]

The camera controller 18 (FIG. 1) may perform, as the imaging control, gain setting for white balance adjustment in the imaging apparatus 1 on the basis of information regarding an image signal value for each of the color components in the skin region extracted by the skin region extractor 202 (FIG. 2).

FIG. 8 illustrates an example of an application to auto white balance to be performed by the imaging control device according to the embodiment.

The camera controller 18 may further include a color-based detection section 82 and a color-based gain setting section 84.

It is possible to determine a skin region color-based detection value 83 by causing the color-based detection section 82 to detect only the skin region with use of the skin map image 43. The color-based gain setting section 84 sets the gain for the white balance adjustment with use of the skin region color-based detection value 83. This allows for white balance adjustment more suitable for the skin.

### [Example of Application to Noise Reduction]

The camera controller 18 (FIG. 1) may cause, as the imaging control, the imaging apparatus 1 to perform a noise reduction process on the skin region on the basis of the information obtained from the skin region extracted by the skin region extractor 202 (FIG. 2).

FIG. 9 illustrates an example of an application to noise reduction by the imaging control apparatus according to the embodiment.

The camera signal processor 13 (FIG. 1) may include a noise reduction process section 92. The camera controller 18 outputs the region-of-interest cutout image 41 to the noise reduction process section 92. This allows the noise reduction process section 92 to refer to the skin map image 43 outputted from the skin region extractor 202, and to perform the noise reduction only on the skin part (a post-noise-reduction image 95). Thus, it is also possible to remove a noise in the skin part without influencing a region other than the skin.

### 1.4 Effects

As described above, according to a technique of the embodiment, the face region of the person in the captured image 31 is detected as the region of interest, and the skin region in the detected region of interest is extracted. The imaging control is performed on the basis of the information obtained from the extracted skin region. It is thus possible to increase detection accuracy of the face region and to perform an appropriate imaging control.

According to the technique of the embodiment, it is possible to extract the skin region inside the region of interest, and to detect the skin region with a blocking object being excluded. The blocking object is an object other than the skin region in the region of interest. This makes it possible to allow, for example, the brightness of the skin region or the amount of flash light emission applied to the skin region to be more appropriate, as compared with a typical method of rectangular detection in the region of interest. It is thus possible to make the brightness of the skin appropriate and to improve image quality of the skin part, for example, even in a case where a dark blocking object such as hair or sunglasses is present inside the detection frame or in a case where the face is directed to the side.

In addition, it is possible to keep calculation accuracy of the region-of-interest brightness even in a scene where it is difficult to extract the skin region, for example, in a scene where it is difficult to extract the skin because it is against light, by calculating the reliability 46 when the skin region is extracted and increasing an employing rate of the rectangle detection value 51 on the basis of the reliability 46. It is thus possible to perform a control such as the exposure control or the flash light emission amount control that is suitable for a face.

In addition, it is also possible to appropriately control a color of the skin part by using the information regarding the skin region in the detection in the auto white balance. In addition, it is also possible to apply the technique according to the embodiment to local image processing by using the information regarding the skin region. Examples of the local image processing include performing the noise reduction only on the skin part.

Note that the effects described herein are mere examples and non-limiting. In addition, any other effect may be achieved. This is similarly applicable to effects of other embodiments described below.

### 2. Other Embodiments

The technique according to the present disclosure is not limited to the description of the embodiment above, and may be modified in various ways.

For example, the present technology may have any of the following configurations.

According to the present technology having any of the following configurations, a face region of a person in a captured image is detected as a region of interest, and a skin region in the detected region of interest is extracted. An imaging control is performed on the basis of information obtained from the extracted skin region. It is thus possible to increase detection accuracy of the face region and to perform an appropriate imaging control.

(1)

An imaging control device including:
a detector that detects, as a region of interest, a face region of a person in a captured image obtained by an imaging apparatus;
an extractor that extracts a skin region in the region of interest detected by the detector; and
a controller that performs an imaging control on the imaging apparatus on the basis of information obtained from the skin region extracted by the extractor.
   (2)

The imaging control device according to (1) described above, further including a brightness calculator that calculates, as the information obtained from the skin region, a brightness of the region of interest on the basis of a detection value of a brightness of the skin region extracted by the extractor.

(3)

The imaging control device according to (2) described above, in which the controller performs, as the imaging control, an exposure control in the imaging apparatus on the basis of information regarding the brightness of the region of interest calculated by the brightness calculator.

(4)

The imaging control device according to (2) or (3) described above, in which the controller performs, as the imaging control, a flash light emission amount control in the imaging apparatus on the basis of information regarding the brightness of the region of interest calculated by the brightness calculator.

(5)

The imaging control device according to any one of (1) to (4) described above, in which the extractor extracts the skin region on the basis of skin region reference data including skin color learning data and skin position learning data.

(6)

The imaging control device according to any one of (1) to (5) described above, in which the extractor calculates reliability of the skin region extracted.

(7)

The imaging control device according to (6) described above, in which the extractor calculates the reliability on the basis of information regarding closeness to a skin color space, probability information regarding a position at which a skin is likely to be present, and information regarding a state of the region of interest at a time of being detected by the detector.

(8)

The imaging control device according to (7) described above, in which the information regarding the state of the region of interest at the time of being detected includes information regarding a size of the region of interest, information regarding a movement speed of the region of interest, and information regarding a brightness of the region of interest.

(9)

The imaging control device according to any one of (2) to (4) described above, in which
the detector sets a rectangular detection frame inside a region-of-interest detection frame that is for detecting the region of interest, and
the brightness calculator calculates, as the information obtained from the skin region, the brightness of the region of interest on the basis of the detection value of the brightness of the skin region and a detection value of a brightness inside the rectangular detection frame.
   (10)

The imaging control device according to (9) described above, in which
the extractor calculates reliability of the skin region extracted, and
the brightness calculator calculates the brightness of the region of interest on the basis of a value in which the detection value of the brightness of the skin region and the detection value of the brightness inside the rectangular detection frame are mixed on the basis of the reliability.
   (11)

The imaging control device according to any one of (1) to (10) described above, in which
the captured image includes a plurality of color components, and
the controller performs, as the imaging control, gain setting for white balance adjustment in the imaging apparatus on the basis of information regarding an image signal value of each of the color components in the skin region extracted by the extractor.
   (12)

The imaging control device according to any one of (1) to (11) described above, in which the controller causes, as the imaging control, the imaging apparatus to perform a noise reduction process on the skin region on the basis of the information obtained from the skin region extracted by the extractor.

(13)

An imaging apparatus including:
an imager;
a detector that detects, as a region of interest, a face region of a person in a captured image obtained by the imager;
an extractor that extracts a skin region in the region of interest detected by the detector; and
a controller that performs an imaging control on the basis of information obtained from the skin region extracted by the extractor.
   (14)

The imaging apparatus according to (13) described above, in which the controller performs, as the imaging control, an exposure control on the imager.

(15)

The imaging apparatus according to (13) or (14) described above, further including
a flash light emitter, in which
the controller performs, as the imaging control, a flash light emission amount control on the flash light emitter.

The present application claims the benefit of Japanese Priority Patent Application JP2022-140338 filed with the Japan Patent Office on Sep. 2, 2022, the entire contents of which are incorporated herein by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An imaging control device comprising:
a detector that detects, as a region of interest, a face region of a person in a captured image obtained by an imaging apparatus;
an extractor that extracts a skin region in the region of interest detected by the detector; and
a controller that performs an imaging control on the imaging apparatus on a basis of information obtained from the skin region extracted by the extractor.

2. The imaging control device according to claim 1, further comprising a brightness calculator that calculates, as the information obtained from the skin region, a brightness of the region of interest on a basis of a detection value of a brightness of the skin region extracted by the extractor.

3. The imaging control device according to claim 2, wherein the controller performs, as the imaging control, an exposure control in the imaging apparatus on a basis of information regarding the brightness of the region of interest calculated by the brightness calculator.

4. The imaging control device according to claim 2, wherein the controller performs, as the imaging control, a flash light emission amount control in the imaging apparatus on a basis of information regarding the brightness of the region of interest calculated by the brightness calculator.

5. The imaging control device according to claim 1, wherein the extractor extracts the skin region on a basis of skin region reference data including skin color learning data and skin position learning data.

6. The imaging control device according to claim 1, wherein the extractor calculates reliability of the skin region extracted.

7. The imaging control device according to claim 6, wherein the extractor calculates the reliability on a basis of information regarding closeness to a skin color space, probability information regarding a position at which a skin is likely to be present, and information regarding a state of the region of interest at a time of being detected by the detector.

8. The imaging control device according to claim 7, wherein the information regarding the state of the region of interest at the time of being detected includes information regarding a size of the region of interest, information regarding a movement speed of the region of interest, and information regarding a brightness of the region of interest.

9. The imaging control device according to claim 2, wherein
the detector sets a rectangular detection frame inside a region-of-interest detection frame that is for detecting the region of interest, and
the brightness calculator calculates, as the information obtained from the skin region, the brightness of the region of interest on a basis of the detection value of the brightness of the skin region and a detection value of a brightness inside the rectangular detection frame.

10. The imaging control device according to claim 9, wherein
the extractor calculates reliability of the skin region extracted, and
the brightness calculator calculates the brightness of the region of interest on a basis of a value in which the detection value of the brightness of the skin region and the detection value of the brightness inside the rectangular detection frame are mixed on a basis of the reliability.

11. The imaging control device according to claim 1, wherein
the captured image includes a plurality of color components, and
the controller performs, as the imaging control, gain setting for white balance adjustment in the imaging apparatus on a basis of information regarding an image signal value of each of the color components in the skin region extracted by the extractor.

12. The imaging control device according to claim 1, wherein the controller causes, as the imaging control, the imaging apparatus to perform a noise reduction process on the skin region on a basis of the information obtained from the skin region extracted by the extractor.

13. An imaging apparatus comprising:
an imager;
a detector that detects, as a region of interest, a face region of a person in a captured image obtained by the imager;
an extractor that extracts a skin region in the region of interest detected by the detector; and
a controller that performs an imaging control on a basis of information obtained from the skin region extracted by the extractor.

14. The imaging apparatus according to claim 13, wherein the controller performs, as the imaging control, an exposure control on the imager.

15. The imaging apparatus according to claim 13, further comprising
a flash light emitter, wherein
the controller performs, as the imaging control, a flash light emission amount control on the flash light emitter.
